(19) United States
(12) Patent Application Publication
(10) Pub. No.: US 2005/0037842 A1
(43) Pub. Date: Feb. 17, 2005

(54) System for casino gaming credit with selectable expiration date

(76) Inventor: Steve Kastner, Las Vegas, NV (US)

Correspondence Address: MARGER JOHNSON & McCOLLOM, P.C., 1030 S.W. Morrison Street, Portland, OR, 97205, US

(21) Appl. No.: 10/838,857

(22) Filed: May 3, 2004

Related U.S. Application Data
(60) Provisional application No. 60/467,762, filed on May 1, 2003.

(51) Int. Cl. A63F 13/00

(52) U.S. Cl. 463/29; 463/42

(57) ABSTRACT

A promotional gaming credit for use on a network of gaming machines has a limited usable life, being inactivated and made unavailable to a gaming player for further use after a predetermined time interval. A method for promoting gaming play on such gaming machines includes providing access to a player account responsive to a command initiated by a player at one of said gaming devices, depositing a promotional credit into the account, associating an expiration date with the promotional credit, and inactivating the promotional credit in accordance with the expiration date. The expiration date can be selectable by a network user.

### CROSS REFERENCE TO RELATED APPLICATIONS

This application claims priority from U.S. provisional application 60/467,762, which is incorporated herein by reference.

### TECHNICAL FIELD

This disclosure is related to the field of casino gaming credits, and more specifically to gaming credits having expiration dates.

### BACKGROUND OF THE INVENTION

Gaming machines are popular entertainment devices providing an opportunity for a user to play a variety of popular games on the machines, such as fruit machines or slot-type games, video adaptations of standard card games like poker and blackjack, and many other types of games.

Modern gaming machines typically are coupled to a gaming network that performs many management type functions, such as accounting, game tracking, player tracking, and player bonusing. Present gaming networks communicate directly with a player by displaying messages on a video display mounted to the gaming machine itself.

The player can input text and answer network-generated questions by using a keyboard that is mounted to the gaming machine near the display, or by making selections on a touchscreen display. Additionally, a player can retrieve information about his electronic account by direct access through the gaming machine or by communicating with a casino employee, who in turn can access the gaming network.

Casinos promote gaming play by encouraging visitors to play gaming machines, and also by offering rewards and other enticements to first-time and repeat players.

Historically, casinos have distributed cash to first-time visitors. For example, a new visitor can be given a container of quarters, which the casino intends for the visitor to use in slot machine play. Such monetary distributions, however, can be used at other casinos and for purposes other than gaming play. Further, the visitor can depart the casino having spent only a portion of the promotional currency amount.

Alternatively, a casino can distribute a player card to a new player, which can be used by the player to access promotional credits. This approach has the advantage over a currency distribution of non-transferability, as the card generally is only operative with the casino's networked gaming machines.

A player receiving promotional credits is not motivated to use all of such credits during the initial visit. A player therefore can play using a fraction of the promotional credits, then return later and use remaining promotional credits. This result is undesirable for the casino, which prefers that the credits be used during the initial visit to maximize gaming play.

Embodiments of the invention address these and other limitations of the prior art.

### BRIEF DESCRIPTION OF THE DRAWINGS

FIGS. 1A and 1B together are a block diagram showing components of a gaming network according to embodiments of the invention.

FIG. 2 is an example screen shot illustrating how to manipulate expiring credits according to embodiments of the invention.

### DETAILED DESCRIPTION OF PREFERRED EMBODIMENT(S)

As has been mentioned, the embodiments of the invention provide incentive to play one or more gaming devices connected by a network to a host computer. In more detail, the present method provides promotional credits to a gaming player, the promotional credits having limited usable “lives,” typically measured in time values, but can also be measured by events or other methods.

As mentioned above, embodiments of the invention operate in conjunction with a gaming network. An example modern gaming network is described in U.S. Pat. No. 6,245,483B 1, assigned to the assignee of the present invention, the teachings of which are incorporated herein in their entirety for all purposes.

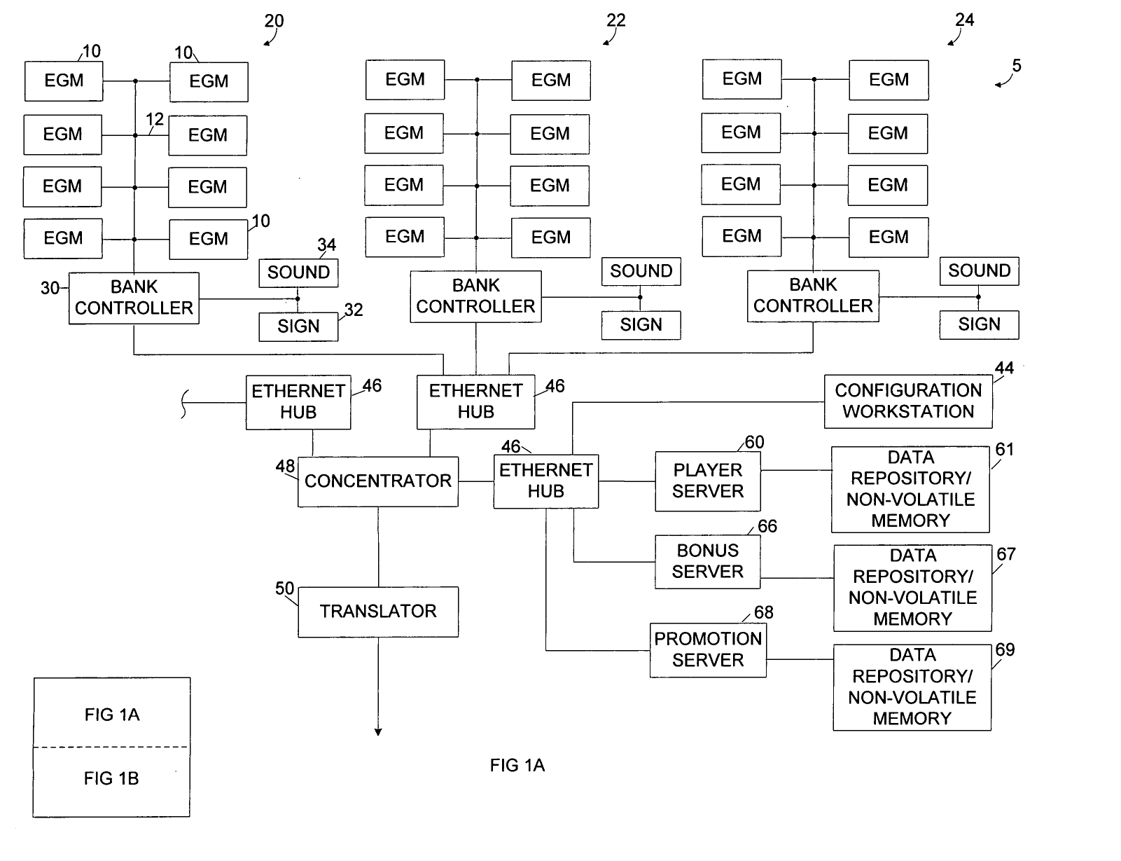

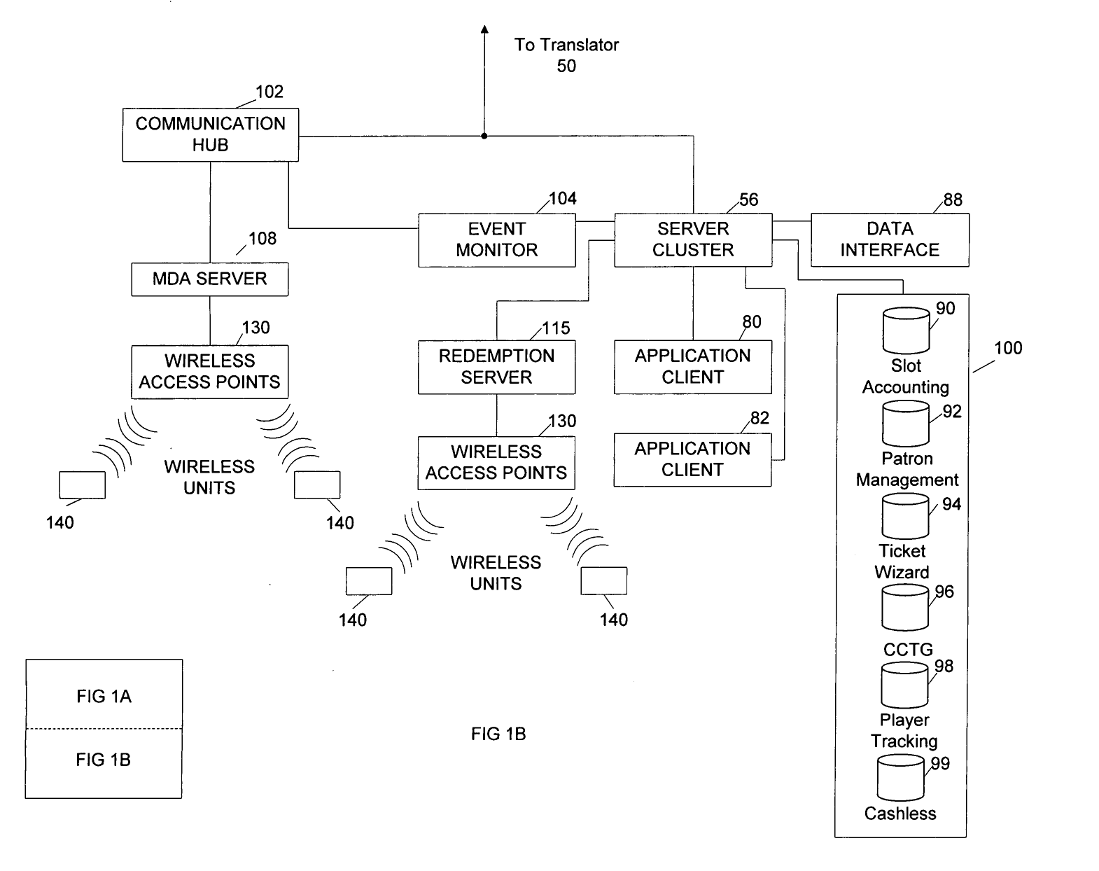

Another such gaming network is illustrated in FIGS. 1A and 1B. In a gaming network 5, a number of EGMs 10 are organized in groups called banks. Individual banks 20, 22, and 24, can contain almost any number of gaming devices 10. Additionally, any number of banks is possible in a gaming network 5.

Each bank is controlled by a bank controller 30, which is coupled to each EGM 10 by a communication cable 12. Other embodiments can use wireless communication between the EGM 10 and other components of the network. The bank controller 30 facilitates data communication between the gaming devices 10 in its associated bank and the other components on the gaming network 5. In some embodiments, the bank controller 30 need not be present, and the EGMs 10 communicate directly with the other portions of the gaming network 5, wired or wirelessly.

Configuration data for the gaming network 5 is stored in one or more network data repositories 61, 67, 69. In some embodiments, the data repositories 61, 67,69 are made of battery backed-up non-volatile SRAM (Static Random Access Memory), which provides dual advantages of having extremely fast data input and output speeds, and having a power source that is independent from the network 5 or the gaming devices 10. The data repositories 61, 67, 69 may also be mirrored, i.e., duplicate copies are made in real-time. This prevents data from being lost if one of the battery sources should fail or other catastrophic event. Data is stored in the data repositories 61, 67, 69 using CRCs (Cyclic Redundancy Checks) and timestamps to ensure the data is valid and non-corrupt.

Configuration data is created at a configuration workstation 44 and stored in the data repositories 61, 67, 69. Configuration data includes message data for players as well as for promotions such as bonuses. Player message data is stored in the data repository 61, where it can be accessed by a player server 60. Player message data can include welcoming messages, card-in/card-out messages, and special messages about current promotions, for instance. The player server 60 reads the message data from the data repository 61 and sends a properly formatted message back to the bank controllers 30 and EGMs 10. These player messages may be displayed on a screen 32 for an entire bank, or may be shown on a screen directly mounted to the EGM 10 (not shown).

Other configuration data created at the configuration workstation 44 and stored in the data repositories 61, 67, 69 includes casino configuration data, such as identification of each EGM 10 on a casino floor. Additional parameters stored in the data repository 67, 69 are parameters used in promotions, such as bonus promotions. These parameters include such items as what EGMs 10 are included in the promotion, how to fund a bonus, i.e., if a bonus is funded by a portion of the coin-in amount of the EGMs 10, by direct funding, or by other methods, and whether a paid bonus is to be taxed or un-taxed, and other parameters.

As players play the EGMs 10 in the gaming network 5, the EGMs send data from their coin meters, or meter values. One or more bonus server 66 and/or promotion server 68 stores these meter values, or summaries of the meter values, in its associated data repository 67. The servers 66, 68 can also operate based on the present and stored meter values to determine an amount of money being wagered on the EGMs in near real-time. The servers 66, 68 can use the amount of money being wagered to calculate bonus pools that are funded as a percentage of the coin-in of participating EGMs 10. For instance, the servers 66, 68 can calculate a present amount of a bonus pool that is funded at one-half of one percent of the coin-in for the participating EGMs 10. An example of bonuses that can be operated from the bonus server 66 includes LUCKY COIN and progressive bonuses, for example, as is known in the art.

Of course, the servers 60, 66, 68 could be embodied in a single device, or in other configurations, and do not have to appear in FIG. 1A, which is only a functional representation. Likewise, the data repositories 61, 67, 69 could be embodied in a single device.

As data is generated by the EGMs 10, data is passed through communication hardware, such as Ethernet hubs 46, and a concentrator 48. Of course, switches or bridges could also be used. The concentrator 48 is also coupled to a translator 50, which includes a compatibility buffer so that the data from the EGMs 10 can be used by a server cluster 56 (FIG. 1B), and other parts of the gaming network 5.

The server cluster 56 (FIG. 1B) may, of course, be embodied by more than one physical server box. In practice, including multiple server boxes with dynamic load sharing and backup capabilities of one another ensures the gaming network 5 is nearly always operational.

The server cluster 56 is attached to and manages several databases, such as a slot accounting database 90, a patron management database 92, a ticket wizard database 94, a “Cage Credit and Table Games” (CCTG) database 96, a player tracking database 98, and a cashless database 99. These databases are collectively referred to as the databases 100. Of course these databases 100 are only exemplary, and more or fewer databases can be part of the gaming network 5. In some embodiments, particular servers in the server cluster 56 manage a single database. For example, a single server in the server cluster 56 may manage the slot accounting database 90, while another server manages the patron management database 92. Such implementation details are well within the expertise of one skilled in the art. However, for ease of illustration, FIG. 1 shows a single server cluster 56 that is coupled to all of the databases 100.

In operation, the slot accounting database 90 receives and stores statistical and financial information about the EGMs, such as dates, times, totals, game outcomes, etc. The patron management database 92 stores information regarding identified players, such as how often and which games they play, how often they stay in the casino, their total loyalty points, past awards, preferences, etc. Expiration dates of different classes of points can be stored in the patron management database 92, along with records or datafields corresponding to data described below. The ticket wizard database 94 stores data about tickets that are issued by the EGMs, such as payouts and cashout tickets, as well as promotional tickets.

The CCTG database 96 stores information about non-EGM 10 data in a casino. That data is typically generated by a client station (not shown) coupled to one of the bank controllers 30. The client station can be located in a casino cage or at a table game, for instance, and data generated by the client station is forwarded to the CCTG database 96 where it is stored. For example, data such as when and how many chips a customer buys, when a customer creates or pays off markers, when a customer cashes checks, etc. is stored in the CCTG database 96.

The player tracking database 98 is a subset database of the patron management database 92, and is used when data retrieval speed is important, such as for real time promotions and bonusing. The cashless database 99 stores information about payment options other than bills, coins, and tokens.

Application clients 80 and 82 couple to the server cluster 56, and can retrieve data from any or all of the databases 100. Application programs run on an application client 80, 82 to provide users information about the gaming network 5 and the casino in which the network is established and to cause functions to operate on the gaming network 5. An example application client 80 could include, for instance, an accounting server that allows queries and provides reports on financial and statistical information on single or groups of EGMs 10.

A promotional credit application can run on one of the application clients 80, 82. In operation, the application allows a casino operator to manage player accounts, including promotional credit, as well as accessing or changing other data on the gaming network 5. The application client 80 may be a standard desktop computer or handheld computer capable of generating signals to interact with the gaming network 5. Screens can be presented to the operator, who selects or inserts data. When the data is operated on by the promotional credit application, data may be changed on the gaming network 5, and in particular on the player management database 92.

A data interface 88 presents a uniform interface to other applications and servers (not shown), and grants access to retrieve data from the databases 100. Typically these other clients or servers would not be controlled by the same entity that provides the other components of the gaming network 5, and therefore the data interface 88 grants only guarded access to the databases 100.

As described above, embodiments of the invention of expiring credits operates on a network such as the one above described. The method is preferably implemented in a system having one or more player electronic accounts. Such an account generally is responsive to a command initiated by a player at one of the gaming devices, and the player account also preferably is accessible over the computer network 5.

A first promotional credit is deposited into a player's account by creating a record in a database stored in the patron management database 92 or in another database. The credit can be “activated,” by indicating it as such, and is available for gaming play by the player. A first expiration date may be associated with the first promotional credit. The first expiration date can be selectable by an operator of the gaming network, or may be automatically generated to have a standard expiration date, for example three months from issue date. The operator can select the first expiration date either before or after activating the first promotional credit.

To effect gaming play, the player identifies themselves to the gaming network 5, most commonly by inserting a player identification card at a card reader at one of the EGMs. Other ways to identify players, such as biometric means, are also known. The electronic account is accessed from the patron management database 92, where the previously entered data record is accessed. If credits are available, matched to the particular player, and have not expired, the first promotional credits are available for play by the player.

When the first expiration date is reached, the promotional credits with which the first expiration date are associated are inactivated, rendering them inaccessible by the player for use in further gaming play.

The first expiration date can be a date associated with the first promotional credit. A calendar function can be utilized to determine the propriety of an inactivation event. The first expiration date is selectable by the casino, such that the variety of lengths of promotions can be offered (e.g., in terms of hours, days or weeks).

Alternatively, the first expiration date can be determined by a duration value associated with the first promotional credit. The first duration value can be decremented in accordance with a passage of time or of discrete units of time. The first promotional credit is inactivated when the first duration value is equal to or less than 0. As above, the first duration value can be set so as to control the length of time that the first promotional credit is available for use by the player.

Still further, the expiration date can be set as another measure, such as expiring at the passage of some event, such as a jackpot. For instance, credits may be given to a group of players but will expire when the first player in the group wins a jackpot, or other particular outcome. In short, the credits can expire (or, conversely, be set to activate) at almost any event or time that can be tracked by the gaming network 5.

An electronic account generally is structured to hold a variety of credits and/or points. For example, a player can “load” a card by purchasing credits. Gaming winnings also can be deposited into the player's electronic account. It is envisioned that these credits would not be subject to an expiration date, but would instead remain available for use in gaming play or refund without temporal limitation. In practice, all of these types of credits, and their associated expiration date(s) are stored as records in the patron management database 92, where they are linked to a particular player account.

A “credit” can be a single monetary value such as a $1 credit. Alternatively, a credit can include a plurality of monetary units to be used in smaller increments, such as a $10 credit that can be used in up to ten $1 gaming plays. In other words, limitations may exist on the way credits are used.

A “credit” can still further mean a point value that can be used for gaming by the player. For example, such points may be structured to be used for gaming play but not be redeemable as cash by the player.

Returning to the electronic account, promotional credits can be “deposited” into the account by creating records therefor. Bonus points, based on gaming play or other factors, also can be deposited in the electronic account. These types of credits and points are not directly purchased by the player, nor do they correlate with gaming jackpots or other winnings subject to strict regulatory control. For these reasons, promotional credits and bonusing points are well-suited to a limited-life constraint, providing an incentive to timely use them.

Embodiments of the present system can accommodate depositing additional promotional credits and associating a second expiration date therewith. The second expiration date can be the same as or different than the first expiration date. Second promotional credits are activated, i.e. made available for to the player for gaming play, and are inactivated in accordance with the second expiration date. There is no limit to the number of different types of credits or the combination of expirations that may be present on a player account.

The electronic account typically is structured to contain at least one credit, and more preferably to contain a plurality of different credit types as described above. In the latter case, embodiments of the invention preferably uses credits in the electronic account that are first to expire. For example, an account can contain first promotional credits having a first expiration date of 01 Jan. 2004. Second promotional credits can be deposited in the account, the second credits having a second expiration date of 01 Dec. 2003.

The method preferably debits second promotional credits from the account of this example when the player next plays a gaming machine, although the second promotional credits having been deposited after the first promotional credits.

The order in which credits are debited from the electronic account can be controlled by defining a use order value for the first promotional credit. Such a use order may be a separate record stored in the patron management database 92, and associated with credits and expiration dates. A non-promotional credit, e.g. a purchased gaming credit or jackpot credit, can be deposited in the account, and a non-promotional use order value defined therefore that differs from the date the expired credits were applied to the account or the expiration date of the credits. Both the first promotional credit and the non-promotional gaming credit are accessible to the player.

The player can swipe his card at one of the networked gaming machines 10 and begin play. Upon receiving a debiting signal from the gaming machine 10, a credit is debited from the player's electronic account in accordance with the use order values of the credits in the account.

Each casino can determine the use order values to be associated with the various credits and points offered by that establishment. In one configuration, promotional credits can have the highest use order values, such that promotional credits are debited from the account before purchased credits, jackpot credits, and other types of direct monetary credits. Additionally, a casino can assign use order values to different promotional credits such that certain promotional credits are debited before others.

A use order can be determined by comparing the use order values of the gaming credits in said electronic account to determine a first-use gaming credit. Such first-use credit would be the credit in the account having the highest use order value. When the player next plays and a debiting signal is sent from the gaming machine, the first-use credit is deducted from the electronic account.

By way of example, a player may receive a new-customer promotional credit and a jackpot enhancement promotional credit. The casino can define a use order value for the jackpot enhancement credit that is higher than that defined for the new-customer credit. According to this example, the jackpot enhancement credit would be debited first when a debiting signal is received from the gaming machine. If the player continued gaming and exhausted all jackpot enhancement credits, the new-customer promotional credit next would be debited.

Other gaming credits in the electronic account can include a second promotional gaming credit, a purchased gaming credit, or a jackpot credit. Because the use order values can be set by the casino, the first-use gaming credit also can be one of a promotional gaming credit, a purchased gaming credit, or a jackpot credit, depending on the particular use order values of the credits in the account.

A situation may arise wherein the wager amount selected by a player exceeds the value of first-use credits in the account. The present method further contemplates comparing the use order values associated with gaming credits in the electronic account to additionally determine a second-use gaming credit. In this manner, a debiting order can be defined for the credits in the account.

For instance, a player may place a $10 wager while her account holds $8 in promotional credits having a highest use order value and another $20 in purchased gaming credits. In this situation, the $8 in promotional credits would be debited as the first-use credits. Additionally, $2 of the gaming credit having the second-highest use order value (i.e., the second-use credit) also would be debited from the account.

### EXAMPLE 1

The method as disclosed can be more completely understood by way of the following specific examples. For ease of explanation, various promotional credits are presented and arbitrarily have been given fanciful and descriptive names. The method as disclosed herein is not to be limited to the particular promotions recited in these illustrative examples, either by promotion title or by specific promotional concept.

Player A visits the casino for the first time on 01 Jan. 2003. A promotional card is distributed to Player A, the card accessing an account having deposited therein $10 in new-customer complimentary credits having a first expiration date of 01 Feb. 2003. An account ledger for this point in time appears in Table 1. A table stored in one of the databases 100 can define a standard time value for promotional credits to expire. For example, the promotional credits may be set to typically expire at the end of the issuance month, or 30 days from the issue date. Once set, the casino operator could vary the standard expiration period, if desired. In this way, the operator need not calculate an expiration date for each credit, but rather the gaming network automatically selects an expiration date, subject to override.

TABLE 1
01 Jan. 2003

| | Use Order | Original | | | | Expiration |
|---|---|---|---|---|---|---|
| Credit | Value | Amount | Used | Expired | Balance | Date |
| New | 1 | $10.00 | $0 | $0 | $10.00 | 01 Feb 2003 |
| Customer | | | | | | |

Player A begins gaming play on that day, using $5 of the complimentary credits with no net winnings. The account summary would be as shown in Table 2.

TABLE 2
02 Jan. 2003

| | Use Order | Original | | | | Expiration |
|---|---|---|---|---|---|---|
| Credit | Value | Amount | Used | Expired | Balance | Date |
| New | 1 | $10.00 | $5.00 | $0 | $5.00 | 01 Feb 2003 |
| Customer | | | | | | |

A second promotional credit (e.g., a Jackpot Celebration promotion) is awarded to Player A during his stay at the casino, increasing his account balance to $10.00. Jackpot Celebration credits, in this example, have an expiration date of 01 Jun. 2003 associated therewith. The account ledger at this stage is summarized in Table 3.

TABLE 3
03 Jan. 2003

| | Use | | | | | |
|---|---|---|---|---|---|---|
| | Order | Original | | | | Expiration |
| Credit | Value | Amount | Used | Expired | Balance | Date |
| New | 1 | $10.00 | $5.00 | $0 | $5.00 | 01 Feb 2003 |
| Customer | | | | | | |
| Celebration | 2 | $5.00 | $0 | $0 | $5.00 | 01 Jun. 2003 |

Player A returns to the casino the following day, using $2.50 in gaming play from the account. The account balance currently is $7.50. In this example, the Jackpot Celebration promotional credits have a higher use order value than the New Customer promotional credits and therefore are first used of the two credit types. The account contents would be as listed in Table 4.

TABLE 4
04 Jan. 2003

| | Use | | | | | |
|---|---|---|---|---|---|---|
| | Order | Original | | | | Expiration |
| Credit | Value | Amount | Used | Expired | Balance | Date |
| New | 1 | $10.00 | $5.00 | $0 | $5.00 | 01 Feb 2003 |
| Customer | | | | | | |
| Celebration | 2 | $5.00 | $2.50 | $0 | $2.50 | 01 Jun. 2003 |

Three months pass before Player A again returns on 31 May 2003 for a second casino visit as part of a tour group. On this visit, the account is accessed and loaded the account with $20.00 in purchased credits. An account summary is reflected in Table 5. Note that the remaining unused New Customer promotional credits have expired on 01 Feb. 2003.

TABLE 5
31 May 2003

| | Use | | | | | |
|---|---|---|---|---|---|---|
| | Order | Original | | | | Expiration |
| Credit | Value | Amount | Used | Expired | Balance | Date |
| New | 1 | $10.00 | $5.00 | $5.00 | $0 | 01 Feb 2003 |
| Customer | | | | | | |
| Celebration | 2 | $5.00 | $2.50 | $0 | $2.50 | 01 Jun. 2003 |
| Purchased | 3 | $20.00 | $0 | — | $20.00 | — |

The next day, Player A notices that the Jackpot Celebration credits are about to expire. To avoid losing these promotional credits, Player A uses $17.50 of the account balance in gaming activity, accruing $5.00 in gaming winnings. The account, now having a balance of $22.50 in credits, is summarized in Table 6.

TABLE 6
01 Jun. 2003

| | Use | | | | | |
|---|---|---|---|---|---|---|
| | Order | Original | | | | Expiration |
| Credit | Value | Amount | Used | Expired | Balance | Date |
| New | 1 | $10.00 | $5.00 | $5.00 | $0 | 01 Feb 2003 |
| Customer | | | | | | |
| Celebration | 2 | $5.00 | $5.00 | $0 | $0 | 01 Jun. 2003 |
| Purchased | 3 | $20.00 | $15.00 | — | $5.00 | — |
| Winnings | 3 | $5.00 | $0 | — | $5.00 | — |

The Jackpot Celebration credits, having an expiration date defined therefor, were assigned a higher use order value by the network than the non-expiring Purchased credits. Thus, the debiting order defined by the use order values of the credits in the account caused the Jackpot Celebration credits to be used before the Purchased credits.

As a result, when Player A caused debiting signals to be received by the network, the remaining $2.50 in Jackpot Celebration credits were determined to be first-use credits and were the first credits to be debited. When additional wagering was performed, $15.00 of the Purchased credits next were debited. These Purchased credits were initially determined to be second-use credits, but became first-use credits when the Jackpot Celebration credits were exhausted.

### EXAMPLE 2

In a second example, Player B also visits the casino for the first time on 01 Jan. 2003. A promotional card is distributed to Player B, the card accessing an account having deposited therein $10 in new-customer complimentary credits having a first expiration date of 01 Feb. 2003. An account ledger for this point in time appears in Table 7.

TABLE 7
01 Jan. 2003

| | Use Order | Original | | | | Expiration |
|---|---|---|---|---|---|---|
| Credit | Value | Amount | Used | Expired | Balance | Date |
| New | 1 | $10.00 | $0 | $0 | $10.00 | 01 Feb 2003 |
| Customer | | | | | | |

Player B begins gaming play on that day, using $2.50 of the complimentary New Customer credits with no net winnings. However, Player B returns the following day to wager an additional $2.50, and wagers another $2.50 on the next day.

The casino notices this player's play over the three-day period and awards Player B $20.00 in Frequent Flyer promotional credits on 05 Jan. 2003. The Frequent Flyer promotional credits are good for seven days. The account summary would be as shown in Table 8.

TABLE 8
04 Jan. 2003

| | Use Order | Original | | | | Expiration |
|---|---|---|---|---|---|---|
| Credit | Value | Amount | Used | Expired | Balance | Date |
| New | 2 | $10.00 | $7.50 | $0 | $2.50 | 01 Feb 2003 |
| Customer | | | | | | |
| Frequent | 1 | $20.00 | $0 | $0 | $0 | 12 Jan 2003 |
| Flyer | | | | | | |

The Frequent Flyer promotion is assigned a higher use order value than the New Customer promotion, per the casino's promotions hierarchy. The latter promotional credits therefore are accorded a revised use order value, such that the Frequent Flyer credits are the first-use credits and the New Customer credits are the second-use credits.

Player B visits the casino later that day, plays $5.00 and wins $10, and departs the casino. The contents of the account at that time are summarized in Table 9.

TABLE 9
05 Jan. 2003

| | Use | | | | | |
|---|---|---|---|---|---|---|
| | Order | Original | | | | Expiration |
| Credit | Value | Amount | Used | Expired | Balance | Date |
| New | 2 | $10.00 | $7.50 | $0 | $2.50 | 01 Feb 2003 |
| Customer | | | | | | |
| Frequent | 1 | $20.00 | $20.00 | $5.00 | $15.00 | 12 Jan 2003 |
| Flyer | | | | | | |
| Winnings | 1 | $5.00 | $0 | — | $5.00 | — |

Player B next visits the casino on 15 Feb. 2003. When accessed, the player electronic account reveals a balance of $5.00; a ledger appears in Table 10. As of this date, the unused New Customer promotional credits and the unused Frequent Flyer promotional credits, originally deposited in the account during the January visit, have expired.

The Winnings, not subject to expiration, remain in the electronic account and available for gaming play or redemption. Further, the Winning credits are now the only credits in the account and therefore are first-use credits.

TABLE 10
15 Feb. 2003

| | Use Order | Original | | | | Expiration |
|---|---|---|---|---|---|---|
| Credit | Value | Amount | Used | Expired | Balance | Date |
| New | — | $10.00 | $7.50 | $2.50 | $0 | 01 Feb 2003 |
| Customer | | | | | | |
| Frequent | — | $20.00 | $5.00 | $15.00 | $0 | 12 Jan 2003 |
| Flyer | | | | | | |
| Winnings | 1 | $5.00 | $0 | — | $5.00 | — |

Player B undertakes gaming play on 15 Feb. 2003, wagering $2.50. Later that day, the network detects Player B's activity and awards Player B $25.00 in Repeat Player promotional credits. These credits are subject to expiration in six months. Table 11 presents the status of the credits that have appeared in the account thus far.

If Player B visits the casino again before 15 Aug. 2003, both the $2.50 in jackpot winnings and the $25.00 in Repeat Player promotional credits will be available for gaming play. Should Player B not return until after 15 Aug. 2003, only the $2.50 in jackpot winnings will remain in the player's account. Player B thereby is motivated to return to the casino.

TABLE 11
16 Feb. 2003

| | Use | | | | | |
|---|---|---|---|---|---|---|
| | Order | Original | | | | Expiration |
| Credit | Value | Amount | Used | Expired | Balance | Date |
| New | — | $10.00 | $7.50 | $2.50 | $0 | 01 Feb 2003 |
| Customer | | | | | | |
| Frequent | — | $20.00 | $5.00 | $15.00 | $0 | 12 Jan 2003 |
| Flyer | | | | | | |
| Repeat | 1 | $25.00 | $0 | $0 | $25.00 | 15 Aug 2003 |
| Player | | | | | | |
| Winnings | 2 | $5.00 | $2.50 | — | $2.50 | — |

Data fields in the above tables can be stored as part of the patron management database 92 (FIG. 1B), which can be accessed elsewhere on the gaming network 5.

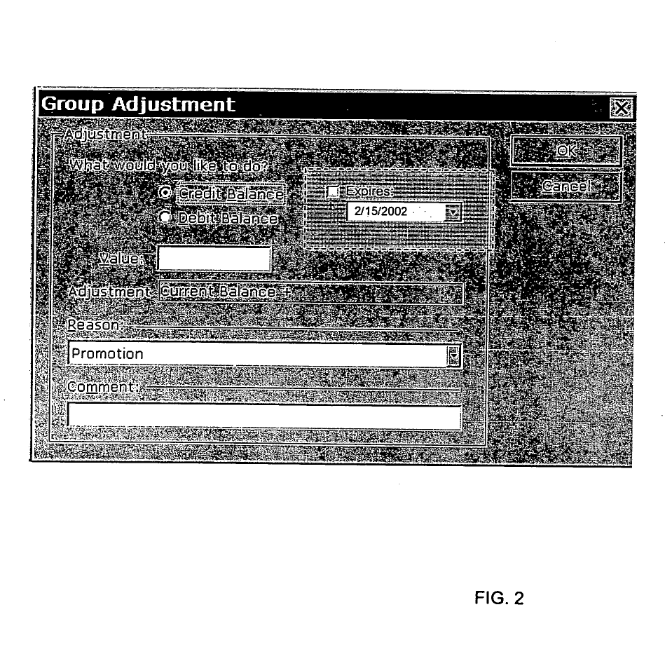

Although examples given above have been with reference to a single player account, expiring credits can be awarded or subtracted for groups of players at the same time. FIG. 2 illustrates a sample screen 200 that appear on one of the application clients 80 (FIG. 1B) that can run a promotional credit application. Using this screen, a casino operator can credit or debit promotional credits to multiple players at the same time. In operation, the operator selects whether to credit or debit the accounts, specifies a value, and selects an expiration date for the added credits. In some embodiments, if the user has high enough permission, the user can select the date for credit expiration. The screen 200 appears after the particular players in the group have already been pre-selected. In other words, the casino operator can select which players should be in the adjustment group, then bring up the screen 200 to make the credit adjustment for the entire group.

A person skilled in the art will be able to practice the present method in view of the description present in this document, which is to be taken as a whole. While the invention has been disclosed in its preferred form, the specific embodiments thereof as disclosed and illustrated herein are not to be considered in a limiting sense. Indeed, it should be readily apparent to those skilled in the art in view of the present description that the invention can be modified in numerous ways.

1. A method of providing incentive to play gaming devices connected by a network to a host computer, comprising:
providing access to a player account responsive to a command initiated by a player at one of said gaming devices, said player account accessible by the host computer;
establishing a first promotional credit into the account, said promotional credit available for gaming play by the player;
associating a first expiration date with said first promotional credit;
establishing a second promotional credit into the account, said second promotional credit available for gaming play by the player;
associating a second expiration date with said second promotional credit, said second expiration date different from said first expiration date;
inactivating said first promotional credit in accordance with said first expiration date; and
inactivating said second promotional credit in accordance with said second expiration date.

2. The method of claim 1 wherein inactivating said first promotional credit occurs before inactivating said second promotional credit when said first expiration date precedes said second expiration date.

3. The method of claim 1, further comprising:
setting a priority use rating for the first promotional credit; and
setting a priority use rating for the second promotional credit.

4. The method of claim 3, wherein inactivating said first promotional credit occurs before inactivating said second promotional credit when said priority use rating for said first promotional credit has a higher value than said priority use rating for said second promotional credit.

5. The method of claim 1, wherein inactivating said first promotional credit occurs before inactivating said second promotional credit when said first promotional credit was deposited before said second promotional credit was deposited.

6. The method of claim 5, wherein inactivating said first promotional credit occurs before inactivating said second promotional credit even when said second expiration date precedes said first expiration date.

7. The method of claim 3, further comprising:
depositing a non-promotional credit into the account, said non-promotional credit having a non-promotional priority use rating defined therefor and further being available for gaming play by the player; and
debiting a credit from the account responsive to a debiting signal received from said one gaming machine and in accordance with said priority use ratings.

8. The method of claim 1, further comprising:
converting points in the player account to a credit responsive to a conversion command initiated by the player at said one gaming device;
debiting the account responsive to a game played at said one gaming device; and
crediting said one gaming device responsive to debiting the account.

9. The method of claim 8, further comprising:
converting credit in the player account back to points in the player account.

10. A system for providing incentive to play gaming devices connected by a network to a host computer, comprising:
providing access to a player account responsive to a command initiated by a player at one of said gaming devices, said player account accessible by the host computer;
creating first promotional gaming credits for association with the account, said first promotional gaming credits available for gaming play by the player;
creating second promotional gaming credits for association with the account, said second promotional gaming credits available for gaming play by the player; and
inactivating said first and second promotional gaming credits based on a predefined rule.

11. The system of claim 10, further comprising:
associating a first expiration date with said first promotional gaming credits; and
associating a second expiration date with said second promotional gaming credits.

12. The system of claim 11 wherein the predefined rule is based on the first and second expiration date.

13. The system of claim 10, further comprising:
assigning a use order rating to said first and second promotional gaming credits.

14. The system of claim 13 wherein the predefined rule is based on the use order rating.

15. The system of claim 10 wherein said first promotional gaming credit is one selected from the group of a promotional gaming credit, a purchased gaming credit, and an earned gaming credit.
